(19) United States
(12) Patent Application Publication
(10) Pub. No.: US 2021/0409984 A1
(43) Pub. Date: Dec. 30, 2021

(54) METHOD OF MONITORING DATA INACTIVITY AND AN ELECTRONIC DEVICE PERFORMING THE METHOD

(71) Applicant: Samsung Electronics Co., Ltd., Suwon-si (KR)

(72) Inventors: Anil AGIWAL, Suwon-si (KR); Hyunjeong KANG, Suwon-si (KR)

(21) Appl. No.: 17/362,275

(22) Filed: Jun. 29, 2021

(30) Foreign Application Priority Data
Jun. 30, 2020 (KR) 10-2020-0080371

(51) Int. Cl. H04W 24/08; H04W 76/38

(52) U.S. Cl. CPC H04W 24/08; H04W 92/10; H04W 76/38

(57) ABSTRACT

Provided is a method, performed by a user equipment (UE) with radio resource control (RRC) connection established, for monitoring data inactivity, the method comprising receiving a timer configuration from a base station (BS), determining whether a sidelink communication is being performed, activating a timer based on the timer configuration and the determination that the sidelink communication is not being performed, restarting the timer at least in case of identifying transmission or reception of at least one media access control address (MAC) service data unit (SDU) with the BS, and releasing the RRC connection when a value of time of the timer is expired.

### CROSS-REFERENCE TO RELATED APPLICATION

This application is based on and claims priority under 35 U.S.C. § 119 to Korean Patent Application No. 10-2020-0080371, filed on Jun. 30, 2020, in the Korean Intellectual Property Office, the disclosure of which is incorporated by reference herein in its entirety.

### BACKGROUND

### 1. Field

The disclosure relates to a method of monitoring data inactivity and an electronic device performing the method.

### 2. Description of Related Art

In the recent years several broadband wireless technologies have been developed to meet the growing number of broadband subscribers and to provide more and better applications and services. The second generation wireless communication system has been developed to provide voice services while ensuring the mobility of users. The third generation wireless communication system supports not only the voice service but also data service. In recent years, the fourth wireless communication system has been developed to provide high-speed data service. However, currently, the fourth generation wireless communication system suffers from lack of resources to meet the growing demand for high speed data services. The fifth generation wireless communication system (also referred as next generation radio or NR) is being developed to meet the growing demand for high speed data services, support ultra-reliability and low latency applications.

The fifth generation wireless communication system, supports a standalone mode of operation as well as dual connectivity (DC). In DC a multiple Rx/Tx UE may be configured to utilize resources provided by two different nodes (or NBs) connected via non-ideal backhaul. One node acts as the Master Node (MN) and the other as the Secondary Node (SN). The MN and SN are connected via a network interface and at least the MN is connected to the core network. NR also supports Multi-RAT Dual Connectivity (MR-DC) operation whereby a UE in RRC_CONNECTED is configured to utilize radio resources provided by two distinct schedulers, located in two different nodes connected via a non-ideal backhaul and providing either E-UTRA (i.e. if the node is an ng-eNB) or NR access (i.e. if the node is a gNB). In NR for a UE in RRC_CONNECTED not configured with CA/DC there is only one serving cell comprising the primary cell. For a UE in RRC_CONNECTED configured with CA/ DC the term ‘serving cells’ is used to denote the set of cells comprising the Special Cell(s) and all secondary cells. In NR the term Master Cell Group (MCG) refers to a group of serving cells associated with the Master Node, comprising the PCell and optionally one or more SCells. In NR the term Secondary Cell Group (SCG) refers to a group of serving cells associated with the Secondary Node, comprising the PSCell and optionally one or more SCells. In NR PCell (primary cell) refers to a serving cell in MCG, operating on the primary frequency, in which the UE either performs the initial connection establishment procedure or initiates the connection re-establishment procedure. In NR for a UE configured with CA, Scell is a cell providing additional radio resources on top of Special Cell. Primary SCG Cell (PSCell) refers to a serving cell in SCG in which the UE performs random access when performing the Reconfiguration with Sync procedure. For Dual Connectivity operation the term SpCell (i.e. Special Cell) refers to the PCell of the MCG or the PSCell of the SCG, otherwise the term Special Cell refers to the PCell.

The 4G and 5G wireless communication systems support vehicular communication services. Vehicular communication services, represented by V2X services, can consist of the following four different types: V2V, V2I, V2N and V2P. In the fifth generation (also referred as NR or New Radio) wireless communication system, V2X communication is being enhanced to support enhanced V2X use cases, which are broadly arranged into four use case groups:

1) Vehicles Platooning enables the vehicles to dynamically form a platoon travelling together. All the vehicles in the platoon obtain information from the leading vehicle to manage this platoon. This information allows the vehicles to drive closer than normal in a coordinated manner, going in the same direction and travelling together.

2) Extended Sensors enables the exchange of raw or processed data gathered through local sensors or live video images among vehicles, road site units, devices of pedestrian and V2X application servers. The vehicles can increase the perception of their environment beyond what their own sensors can detect and have a more broad and holistic view of the local situation. High data rate is one of the key characteristics.

3) Advanced Driving enables semi-automated or full-automated driving. Each vehicle and/or RSU shares its own perception data obtained from its local sensors with vehicles in proximity and that allows vehicles to synchronize and coordinate their trajectories or maneuvers. Each vehicle also shares its driving intention with vehicles in proximity.

4) Remote Driving enables a remote driver or a V2X application to operate a remote vehicle for those passengers who cannot drive by themselves or remote vehicles located in dangerous environments. For a case where variation is limited and routes are predictable, such as public transportation, driving based on cloud computing can be used. High reliability and low latency are the main requirements.

V2X services can be provided by a PC5 interface and/or a Uu interface. Support of V2X services via the PC5 interface is provided by NR sidelink communication or V2X sidelink communication, which is a mode of communication whereby UEs can communicate with each other directly over the PC5 interface using NR technology or EUTRA technology respectively without traversing any network node. This communication mode is supported when the UE is served by RAN and when the UE is outside of RAN coverage. Only the UEs authorized to be used for V2X services can perform NR or V2X sidelink communication. The NG-RAN architecture supports the PC5 interface as illustrated in FIG. 1. Sidelink transmission and reception over the PC5 interface are supported when the UE is inside NG-RAN coverage, irrespective of which RRC state the UE is in, and when the UE is outside NG-RAN coverage. Support of V2X services via the PC5 interface can be provided by NR Sidelink Communication and/or V2X Sidelink Communication. NR Sidelink Communication may be used to support other services than V2X services.

NR or V2X Sidelink Communication can support three types of transmission modes. Unicast transmission, characterized by support of at least one PC5-RRC connection between peer UEs; Transmission and reception of control information and user traffic between peer UEs in sidelink; Support of sidelink HARQ feedback; Support of RLC AM; and Support of sidelink RLM for both peer UEs to detect RLF. Groupcast transmission, characterized by:

Transmission and reception of user traffic among UEs belonging to a group in sidelink; Support of sidelink HARQ feedback. Broadcast transmission, characterized by: Transmission and reception of user traffic among UEs in sidelink.

The AS protocol stack for the control plane in the PC5 interface consists of RRC, PDCP, RLC and MAC sublayer, and the physical layer. The AS protocol stack for user plane in the PC5 interface consists of SDAP, PDCP, RLC and MAC sublayer, and the physical layer. Sidelink Radio bearers (SLRB) are categorized into two groups: sidelink data radio bearers (SL DRB) for user plane data and sidelink signalling radio bearers (SL SRB) for control plane data. Separate SL SRBs using different SCCHs are configured for PC5-RRC and PC5-S signaling respectively.

The MAC sublayer provides the following services and functions over the PC5 interface:-Radio resource selection; Packet filtering; Priority handling between uplink and sidelink transmissions for a given UE; Sidelink CSI reporting. With LCP restrictions in MAC, only sidelink logical channels belonging to the same destination can be multiplexed into a MAC PDU for every unicast, groupcast and broadcast transmission which is associated to the destination. NG-RAN can also control whether a sidelink logical channel can utilize the resources allocated to a configured sidelink grant Type 1. For packet filtering, a SL-SCH MAC header including portions of both Source Layer-2 ID and a Destination Layer-2 ID is added to each MAC PDU as specified in subclause 8.x. LCID included within a MAC subheader uniquely identifies a logical channel within the scope of the Source Layer-2 ID and Destination Layer-2 ID combination. The following logical channels are used in sidelink:
Sidelink Control Channel (SCCH): a sidelink channel for transmitting control information from one UE to other UE(s);
Sidelink Traffic Channel (STCH): a sidelink channel for transmitting user information from one UE to other UE(s);
Sidelink Broadcast Control Channel (SBCCH): a sidelink channel for broadcasting sidelink system information from one UE to other UE(s).

The following connections between logical channels and transport channels exist:
SCCH can be mapped to SL-SCH;
STCH can be mapped to SL-SCH;
SBCCH can be mapped to SL-BCH.

The RRC sublayer provides the following services and functions over the PC5 interface:
Transfer of a PC5-RRC message between peer UEs;
Maintenance and release of a PC5-RRC connection between two UEs;
Detection of sidelink radio link failure for a PC5-RRC connection.

A PC5-RRC connection is a logical connection between two UEs for a pair of Source and Destination Layer-2 IDs which is considered to be established after a corresponding PC5 unicast link is established as specified in TS 23.287. There is one-to-one correspondence between the PC5-RRC connection and the PC5 unicast link. A UE may have multiple PC5-RRC connections with one or more UEs for different pairs of Source and Destination Layer-2 IDs. Separate PC5-RRC procedures and messages are used for a UE to transfer UE capability and sidelink configuration including SLRB configuration to the peer UE. Both peer UEs can exchange their own UE capability and sidelink configuration using separate bi-directional procedures in both sidelink directions. If it is not interested in sidelink transmission, if sidelink RLF on the PC5-RRC connection is declared, or if the Layer-2 link release procedure is completed as specified in TS 23.287, the UE releases the PC5-RRC connection.

The UE can operate in two modes for resource allocation in sidelink:
Scheduled resource allocation, characterized by:
The UE needs to be RRC_CONNECTED in order to transmit data;
NG-RAN schedules transmission resources.
UE autonomous resource selection, characterized by:
The UE can transmit data when inside NG-RAN coverage, irrespective of which RRC state the UE is in, and when outside NG-RAN coverage;
The UE autonomously selects transmission resources from a pool of resources.
For NR sidelink communication, the UE performs sidelink transmissions only on a single carrier.

Scheduled Resource Allocation: NG-RAN can dynamically allocate resources to the UE via the SL-RNTI on PDCCH(s) for NR sidelink Communication. In addition, NG-RAN can allocate sidelink resources to UE with two types of configured sidelink grants:
With type 1, RRC directly provides the configured sidelink grant for NR sidelink communication
With type 2, RRC provides the periodicity of the configured sidelink grant while PDCCH can either signal and activate the configured sidelink grant, or deactivate it. The PDCCH provides the actual grant (i.e. resources) to be used. The PDCCH is addressed to SL-CS-RNTI for NR sidelink communication and SL Semi-Persistent Scheduling V-RNTI for V2X sidelink communication.

For the UE performing NR sidelink communication, there can be more than one configured sidelink grant activated at a time on the carrier configured for sidelink transmission. When beam failure or physical layer problem occurs on NR Uu, the UE can continue using the configured sidelink grant Type 1. During handover, the UE can be provided with configured sidelink grants via handover command, regardless of the type. If provided, the UE activates the configured sidelink grant Type 1 upon reception of the handover command. The UE can send sidelink buffer status report to support scheduler operation in NG-RAN. The sidelink buffer status reports refer to the data that is buffered in for a group of logical channels (LCG) per destination in the UE. Eight LCGs are used for reporting of the sidelink buffer status reports. Two formats, which are SL BSR and truncated SL BSR, are used.

UE Autonomous Resource Allocation: The UE autonomously selects sidelink grant from a pool of resources provided by broadcast system information or dedicated signalling while inside NG-RAN coverage or by preconfiguration while outside NG-RAN coverage.

For NR sidelink communication, the pools of resources can be provided for a given validity area where the UE does not need to acquire a new pool of resources while moving within the validity area, at least when this pool is provided by SIB (e.g. reuse valid area of NR SIB). The NR SIB validity mechanism is reused to enable the validity area for the SL resource pool configured via broadcasted system information. The UE is allowed to temporarily use UE autonomous resource selection with random selection for sidelink transmission based on configuration of the exceptional transmission resource pool.

For V2X sidelink transmission, during handover, transmission resource pool configurations including exceptional transmission resource pool for the target cell can be signaled in the handover command to reduce the transmission interruption. In this way, the UE may use the V2X sidelink transmission resource pools of the target cell before the handover is completed as long as either synchronization is performed with the target cell in case eNB is configured as the synchronization source or synchronization is performed with GNSS in case GNSS is configured as the synchronization source. If the exceptional transmission resource pool is included in the handover command, the UE uses randomly selected resources from the exceptional transmission resource pool, starting from the reception of handover command. If the UE is configured with scheduled resource allocation in the handover command, the UE continues to use the exceptional transmission resource pool while the timer associated with handover is running. If the UE is configured with autonomous resource selection in the target cell the UE continues to use the exceptional transmission resource pool until the sensing results on the transmission resource pools for autonomous resource selection are available. For exceptional cases (e.g. during RLF, during transition from RRC IDLE to RRC CONNECTED or during change of dedicated V2X sidelink resource pools within a cell), the UE may select resources in the exceptional pool provided in serving cell's SIB21 or in dedicated signalling based on random selection, and uses them temporarily. During cell reselection, the RRC_IDLE UE may use the randomly selected resources from the exceptional transmission resource pool of the reselected cell until the sensing results on the transmission resource pools for autonomous resource selection are available.

### SUMMARY

In the fifth generation wireless communication system, data inactivity monitoring is supported between the UE and the gNB. The gNB configures the dataInactivityTimer in RRC_CONNECTED via an RRC message. In the UE there can be two MAC entities (one in MCG and another in SCG). If any MAC entity receives a MAC SDU for DTCH logical channel, DCCH logical channel, or CCCH logical channel, the dataInactivityTimer is started. Note that DTCH/DCCH/CCCH logical channel are for exchanging MAC SDUs between the UE and the gNB (Master gNB in case of MCG and Secondary gNB in case of SCG). If any MAC entity transmits a MAC SDU for DTCH logical channel, or DCCH logical channel, the dataInactivityTimer is started. If the dataInactivityTimer expires, the UE releases the RRC connection and enters RRC_IDLE.

SL operation for V2X communication is recently introduced for fifth generation wireless communication system. The UE can be in RRC_CONNECTED for V2X communication where V2X communication is controlled by gNB. During V2X communication data is exchanged over sidelink (SL) between UEs. In case of V2X communication while the UE is in RRC_CONNECTED, there may not be any activity with respect to DTCH/DCCH/CCCH in both UL and DL. The UE may be only receiving PDCCH for SL grant(s) in DL. In this case the dataInactivityTimer will expire and will lead to RRC connection release. This interrupts the ongoing V2X communication.

The technical idea disclosed herein is intended to solve the foregoing problems, and provides a method of monitoring data in activity in NR communication or V2X communication and an electronic device that performs the method.

Additional aspects will be set forth in part in the description which follows and, in part, will be apparent from the description, or may be learned by practice of the presented embodiments of the disclosure.

According to an embodiment of the disclosure, a method, performed by a user equipment (UE) with radio resource control (RRC) connection established, for monitoring data inactivity, may comprise receiving a timer configuration from a base station (BS), determining whether a sidelink communication is being performed, activating a timer based on the timer configuration and the determination that the sidelink communication is not being performed, restarting the timer at least in case of identifying transmission or reception of at least one media access control address (MAC) service data unit (SDU) with the BS, and releasing the RRC connection when a value of time of the timer is expired.

According to another embodiment of the disclosure, a user equipment (UE) with radio resource control (RRC) connection established, may comprise a transceiver and at least one processor. The at least one processor may be configured to receive a timer configuration from a base station (BS), determine whether a sidelink communication is being performed, activate a timer based on the timer configuration and the determination that the sidelink communication is not being performed, restart the timer at least in case of identifying transmission or reception of at least one media access control address (MAC) service data unit (SDU) with the BS, and release the RRC connection when a value of time of the timer is expired.

According to an embodiment of the disclosure, a method, performed by a base station (BS) in a wireless communication system, for monitoring data inactivity, may comprise determining whether a sidelink communication configuration has been provided to a user equipment (UE) with radio resource control (RRC) connection established and transmitting a timer configuration to the UE based on the determination that the sidelink communication configuration has not been provided to the UE.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates an NG-RAN architecture supporting PC5 interface;

FIG. 2 illustrates a flowchart of a method, performed by a user equipment (UE), of monitoring data inactivity, according to an embodiment of the disclosure;

FIG. 3 illustrates a flowchart of a method, performed by a user equipment (UE), of monitoring data inactivity, according to an embodiment of the disclosure;

FIG. 4 illustrates a flowchart of a method, performed by a user equipment (UE), of monitoring data inactivity, according to an embodiment of the disclosure;

FIG. 5 illustrates a flowchart of a method, performed by a user equipment (UE), of monitoring data inactivity, according to an embodiment of the disclosure;

FIG. 6 illustrates a flowchart of a method, performed by a user equipment (UE), of monitoring data inactivity, according to an embodiment of the disclosure;

FIG. 7 illustrates a flowchart of a method, performed by a user equipment (UE), of monitoring data inactivity, according to an embodiment of the disclosure;

FIG. 8 illustrates a flowchart of a method, performed by a base station (BS), of monitoring data inactivity, according to an embodiment of the disclosure;

FIG. 9 illustrates a flowchart of a method, performed by a user equipment (UE), of monitoring data inactivity, according to an embodiment of the disclosure;

FIG. 10 illustrates a flowchart of a method, performed by a user equipment (UE), of monitoring data inactivity, according to an embodiment of the disclosure;

FIG. 11 illustrates a flowchart of a method, performed by a base station (BS), of monitoring data inactivity, according to an embodiment of the disclosure;

FIG. 12 illustrates a block diagram of a user equipment (UE) for monitoring data inactivity, according to an embodiment of the disclosure; and

FIG. 13 illustrates a block diagram of a network entity for monitoring data inactivity, according to an embodiment of the disclosure.

With regard to the description of the drawings, the same or similar reference numerals may be used to refer to the same or similar components.

### DETAILED DESCRIPTION

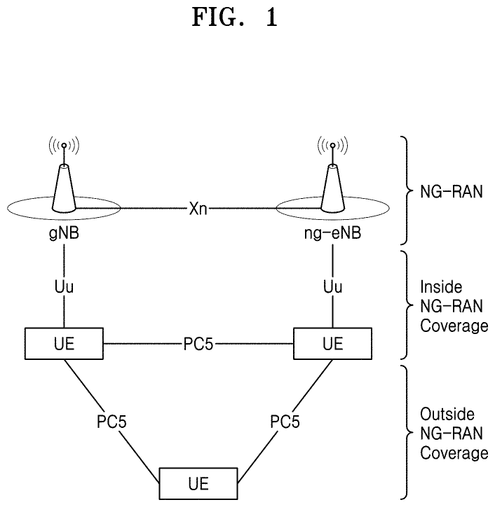

FIGS. 1 through 13, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The following description with reference to accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

While describing the embodiments, technical content that is well known in the related fields and not directly related to the disclosure will not be provided. By omitting redundant descriptions, the essence of the disclosure will not be obscured and may be clearly explained.

For the same reasons, components may be exaggerated, omitted, or schematically illustrated in drawings for clarity. Also, the size of each component does not completely reflect the actual size. In the drawings, like reference numerals denote like elements.

As used herein, the term “and/or” includes any and all combinations of one or more of the associated listed items. Expressions such as “at least one of” when preceding a list of elements, modify the entire list of elements and do not modify the individual elements of the list. Throughout the disclosure, the expression “at least one of a, b or c” indicates only a, only b, only c, both a and b, both a and c, both b and c, all of a, b, and c, or variations thereof.

Advantages and features of one or more embodiments of the disclosure and methods of accomplishing the same may be understood more readily by reference to the following detailed description of the embodiments and the accompanying drawings. In this regard, the present embodiments may have different forms and should not be construed as being limited to the descriptions set forth herein. Rather, these embodiments are provided so that this disclosure will be thorough and complete and will fully convey the concept of the present embodiments to one of ordinary skill in the art, and the disclosure will only be defined by the appended claims.

Here, it will be understood that combinations of blocks in flowcharts or process flow diagrams may be performed by computer program instructions. Since these computer program instructions may be loaded into a processor of a general purpose computer, a special purpose computer, or another programmable data processing apparatus, the instructions, which are performed by a processor of a computer or another programmable data processing apparatus, create units for performing functions described in the flowchart block(s). The computer program instructions may be stored in a computer-usable or computer-readable memory capable of directing a computer or another programmable data processing apparatus to implement a function in a particular manner, and thus the instructions stored in the computer-usable or computer-readable memory may also be capable of producing manufacturing items containing instruction units for performing the functions described in the flowchart block(s). The computer program instructions may also be loaded into a computer or another programmable data processing apparatus, and thus, instructions for operating the computer or the other programmable data processing apparatus by generating a computer-executed process when a series of operations are performed in the computer or the other programmable data processing apparatus may provide operations for performing the functions described in the flowchart block(s).

In addition, each block may represent a portion of a module, segment, or code that includes one or more executable instructions for executing specified logical function(s). It should also be noted that in some alternative implementations, functions mentioned in blocks may occur out of order. For example, two blocks illustrated consecutively may actually be executed substantially concurrently, or the blocks may sometimes be performed in a reverse order according to the corresponding function.

Here, the term “unit” in the embodiments of the disclosure means a software component or hardware component such as a field-programmable gate array (FPGA) or an application-specific integrated circuit (ASIC) and performs a specific function. However, the term “unit” is not limited to software or hardware. The “unit” may be formed so as to be in an addressable storage medium, or may be formed so as to operate one or more processors. Thus, for example, the term “unit” may refer to components such as software components, object-oriented software components, class components, and task components, and may include processes, functions, attributes, procedures, subroutines, segments of program code, drivers, firmware, micro codes, circuits, data, a database, data structures, tables, arrays, or variables. A function provided by the components and “units” may be associated with a smaller number of components and “units”, or may be divided into additional components and “units”. Furthermore, the components and “units” may be embodied to reproduce one or more central processing units (CPUs) in a device or security multimedia card. Also, in the embodiments, the “unit” may include at least one processor. In the disclosure, a controller may also be referred to as a processor.

A wireless communication system has evolved from providing initial voice-oriented services to, for example, a broadband wireless communication system providing a high-speed and high-quality packet data service, such as communication standards of high speed packet access (HSPA), long-term evolution (LTE) or evolved universal terrestrial radio access (E-UTRA), and LTE-Advanced (LTE-A) of 3GPP, high rate packet data (HRPD) and ultra mobile broadband (UMB) of 3GPP2, and IEEE 802.16e. A 5th generation (5G) or new radio (NR) communication standards are being developed with 5G wireless communication systems.

Hereinafter, one or more embodiments will be described with reference to accompanying drawings. Also, in the description of the disclosure, certain detailed explanations of related functions or configurations are omitted when it is deemed that they may unnecessarily obscure the essence of the disclosure. All terms including descriptive or technical terms which are used herein should be construed as having meanings that are obvious to one of ordinary skill in the art. However, the terms may have different meanings according to an intention of one of ordinary skill in the art, precedent cases, or the appearance of new technologies, and thus, the terms used herein have to be defined based on the meaning of the terms together with the description throughout the specification. Hereinafter, a base station may be a subject performing resource assignment of a terminal, and may be at least one of a gNode B, an eNode B, a Node B, a base station (BS), a wireless access unit, a base station controller, and a node on a network. A terminal may include user equipment (UE), a mobile station (MS), a cellular phone, a smart phone, a computer, or a multimedia system capable of performing communication functions, or the like. In the disclosure, a DL is a wireless transmission path of a signal transmitted from a base station to a terminal, and a UL is a wireless transmission path of a signal transmitted from a terminal to a base station. Throughout the specification, a layer (or a layer apparatus) may also be referred to as an entity. Also, hereinbelow, one or more embodiments of the disclosure will be described as an example of an LTE or LTE-A system, but the one or more embodiments may also be applied to other communication systems having a similar technical background or channel form. For example, 5G mobile communication technology (5G, new radio, NR) developed after LTE-A may be included. In addition, the one or more embodiments may be applied to other communication systems through some modifications within the scope of the disclosure without departing from the scope of the disclosure according to a person skilled in the art.

In an LTE system as a representative example of the broadband wireless communication system, an orthogonal frequency division multiplexing (OFDM) scheme is used in a DL and a single carrier frequency division multiplexing (SC-FDMA) scheme is used in a UL. The UL refers to a wireless link through which a terminal, UE, or a MS transmits data or control signals to a BS or a gNode B, and the DL refers to a wireless link through which a BS transmits data or control signals to a terminal. In such a multiple access scheme, data or control information of each user is classified by generally assigning and operating the data or control information such that time-frequency resources for transmitting data or control information for each user do not overlap each other, that is, such that orthogonality is established.

Terms such as a physical channel and a signal in an existing LTE or LTE-A system may be used to describe methods and apparatuses suggested in the disclosure. However, the content of the disclosure is applied to a wireless communication system, instead of the LTE or LTE-A system.

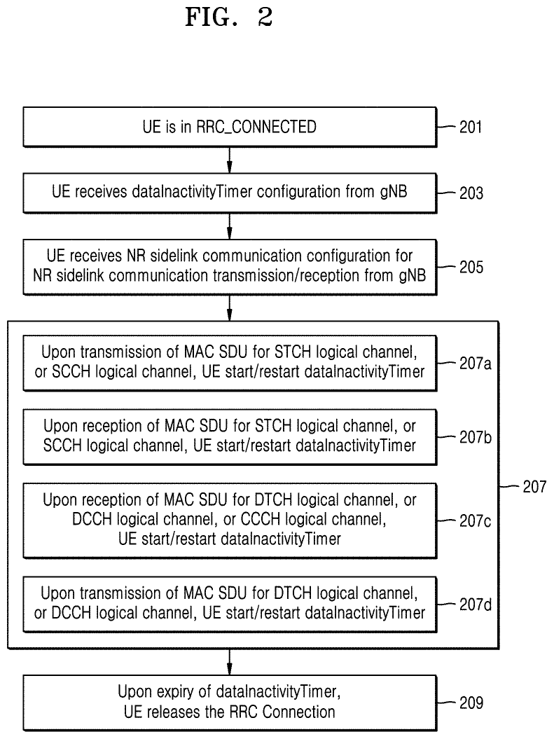

FIG. 2 illustrates a flowchart of a method, performed by a user equipment (UE), of monitoring data inactivity, according to an embodiment of the disclosure.

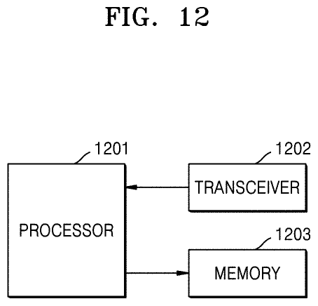

Referring to FIG. 2, a method, performed by a UE, of monitoring data inactivity may include operations 201 through 209. The operation 207 may include at least one of operation 207a, operation 207b, operation 207c, and operation 207d. According to various embodiments of the disclosure, operations 201 through 209 may be performed by the processor 1201 shown in FIG. 12.

In one method of this disclosure it is proposed that if the dataInactivityTimer is configured by the gNB to RRC_CONNECTED UE and this UE has received NR sidelink communication configuration from the gNB for performing NR sidelink communication transmission and/or NR sidelink communication reception:

upon transmission of a MAC SDU over sidelink for STCH logical channel or SCCH logical channel, the UE (re-) starts the dataInactivityTimer. The STCH and SCCH logical channels are mapped to the SL-SCH transport channel, which is mapped to the PSSCH physical layer channel. The STCH and SCCH logical channels carry the MAC SDUs for NR sidelink communication between UEs;

upon reception of a MAC SDU for sidelink for the STCH logical channel or the SCCH logical channel, the UE (re-) starts the dataInactivityTimer. The STCH and SCCH logical channels are mapped to the SL-SCH transport channel, which is mapped to the PSSCH physical layer channel. The STCH and SCCH logical channels carry the MAC SDUs for NR sidelink communication between UEs;

upon reception of a MAC SDU for the DTCH logical channel, or the DCCH logical channel, or the CCCH logical channel, the UE starts/restarts the dataInactivityTimer. The DTCH, DCCH and CCCH logical channels carry the MAC SDUs for communication between UE and gNB. The UE receives the MAC SDU for the DTCH logical channel, or the DCCH logical channel, or the CCCH logical channel from the gNB;

upon transmission of a MAC SDU for the DTCH logical channel, or the DCCH logical channel, the UE starts/restarts the dataInactivityTimer. The UE transmits the MAC SDU for the DTCH logical channel, or the DCCH logical channel to the gNB.

In the above operation transmission/reception of MAC SDU for NR sidelink communication is based on the NR sidelink communication configuration received from the gNB. Upon expiry of the dataInactivityTimer, the UE releases the RRC Connection.

In an embodiment, the UE operation is illustrated in FIG. 2. The UE is in RRC_CONNECTED (operation 201). The UE receives the dataInactivityTimer configuration from the gNB where the configuration can be received in the RRCReconfiguration message (operation 203). The UE receives NR sidelink communication configuration for NR sidelink communication transmission/reception (operation 205). The UE performs transmission/reception of the NR sidelink communication according to the NR sidelink communication configuration received from the gNB (operation 207). Upon transmission of the MAC SDU for the STCH logical channel, or the SCCH logical channel, the UE starts/restarts the dataInactivityTimer (operation 207a). Upon reception of the MAC SDU for the STCH logical channel, or the SCCH logical channel, the UE starts/restarts the dataInactivityTimer (operation 207b). Upon reception of the MAC SDU for the DTCH logical channel, or the DCCH logical channel, or the CCCH logical channel, the UE starts/restarts the dataInactivityTimer (operation 207c). Upon transmission of the MAC SDU for the DTCH logical channel, or the DCCH logical channel, the UE starts/restarts the dataInactivityTimer (operation 207d). Upon expiry of the dataInactivityTimer, the UE releases the RRC Connection (operation 209). In the above operation transmission/reception of the MAC SDU for NR sidelink communication is based on the NR sidelink communication configuration received from the gNB. In other words it is not based on pre configuration. Note that the UE can be pre-configured with the NR sidelink communication configuration for NR sidelink communication transmission/reception, which the UE uses if it is not in coverage of any cell on frequency used for NR sidelink communication.

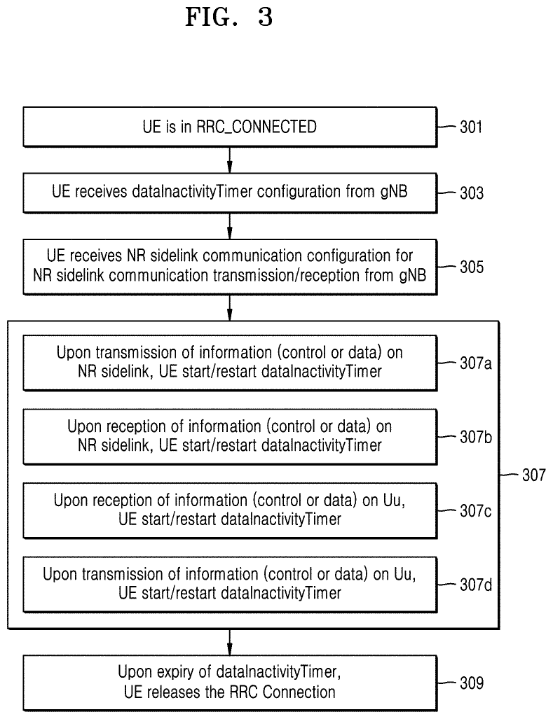

FIG. 3 illustrates a flowchart of a method, performed by a user equipment (UE), of monitoring data inactivity, according to an embodiment of the disclosure.

Referring to FIG. 3, a method, performed by a UE, of monitoring data inactivity may include operations 301 through 309. The operation 307 may include at least one of operation 307a, operation 307b, operation 307c, and operation 307d. According to various embodiments of the disclosure, operations 301 through 309 may be performed by the processor 1201 shown in FIG. 12.

In an embodiment, the UE operation is illustrated in FIG. 3. The UE is in RRC_CONNECTED (operation 301). The UE receives the dataInactivityTimer configuration from the gNB where the configuration can be received in the RRCReconfiguration message (operation 303). The UE receives NR sidelink communication configuration for NR sidelink communication transmission/reception (operation 305). The UE performs transmission/reception of the NR sidelink communication according to the NR sidelink communication configuration received from the gNB (operation 307). Upon transmission of information (control or data) on NR sidelink, the UE starts/restarts the dataInactivityTimer (operation 307a). Upon reception of information (control or data) on NR sidelink, the UE starts/restarts the dataInactivityTimer (operation 307b). Upon reception of information (control or data) on Uu (the communication link between the UE and the gNB is referred as Uu), the UE starts/restarts the dataInactivityTimer (operation 307c). Upon transmission of information (control or data) on Uu, the UE starts/restarts the dataInactivityTimer (operation 307d). Upon expiry of the dataInactivityTimer, the UE releases the RRC Connection (operation 309). In the above operation transmission/reception on the NR sidelink is based on the NR sidelink communication configuration received from the gNB. In other words it is not based on pre configuration. Note that the UE can be pre-configured with the NR sidelink communication configuration for the NR sidelink communication transmission/reception, which the UE uses if it is not in coverage of any cell on frequency used for NR sidelink communication.

The UE operation for Data inactivity monitoring can be specified in the NR standard as follows:

The UE may be configured by RRC with a Data inactivity monitoring functionality, when in RRC_CONNECTED. The RRC controls Data inactivity operation by configuring the timer dataInactivityTimer.

When the dataInactivityTimer is configured, the UE shall:

1>if any MAC entity receives a MAC SDU for the DTCH logical channel, the DCCH logical channel, or the CCCH logical channel; or

1>if any MAC entity transmits a MAC SDU for the DTCH logical channel, or the DCCH logical channel, regardless of LBT failure indication from lower layers; or

1>if MAC entity (or any MAC entity) transmits a MAC SDU for the STCH logical channel, or the SCCH logical channel using the NR sidelink communication configuration received from the gNB (or the SpCell or PCell); or

1>if MAC entity (or any MAC entity) receives a MAC SDU for the STCH logical channel, or the SCCH logical channel using the NR sidelink communication configuration received from the gNB (or the SpCell or PCell):
2>start or restart the dataInactivityTimer.

1>if the the dataInactivityTimer expires:
2>indicate the expiry of the dataInactivityTimer to upper layers (i.e. RRC). The RRC releases the RRC connection and enters the RRC_IDLE upon receiving the indication.

Note the gNB is the base station of NR RAT.

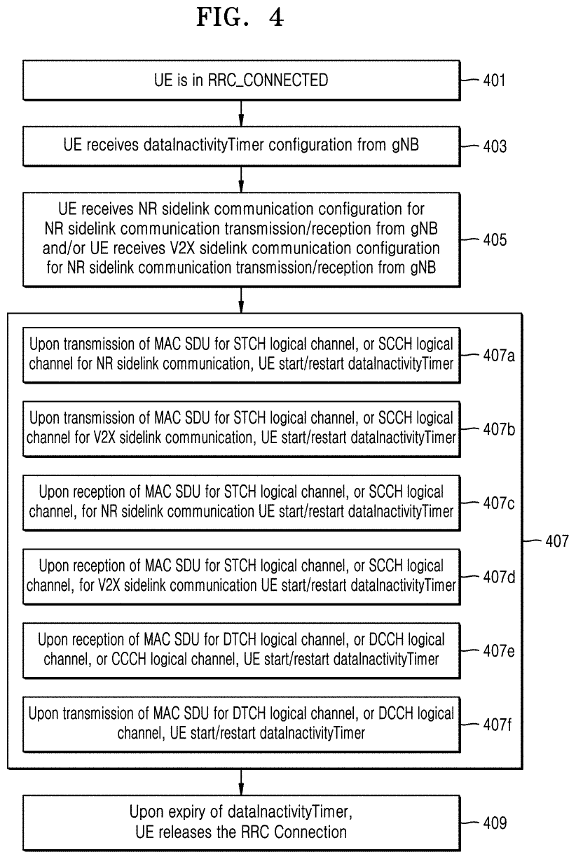

FIG. 4 illustrates a flowchart of a method, performed by a user equipment (UE), of monitoring data inactivity, according to an embodiment of the disclosure.

Referring to FIG. 4, a method, performed by a UE, of monitoring data inactivity may include operations 401 through 409. The operation 407 may include at least one of operation 407a, operation 407b, operation 407c, operation 407d, operation 407e, and operation 407f. According to various embodiments of the disclosure, operations 401 through 409 may be performed by the processor 1201 shown in FIG. 12.

In one method of this disclosure it is proposed that if the dataInactivityTimer is configured by the gNB to RRC_CONNECTED UE and this UE has received sidelink communication configuration (NR sidelink communication and/or V2X sidelink communication) from the gNB for performing sidelink communication (NR sidelink communication and/or V2X sidelink communication) transmission and/or sidelink communication (NR sidelink communication and/or V2X sidelink communication) reception:

upon transmission of a MAC SDU over sidelink for the STCH logical channel or the SCCH logical channel for V2X sidelink communication, the UE (re-) starts the dataInactivityTimer;

upon transmission of a MAC SDU over sidelink for the STCH logical channel or the SCCH logical channel for NR sidelink communication, the UE (re-) starts the dataInactivityTimer;

upon reception of a MAC SDU for sidelink for the STCH logical channel or the SCCH logical channel for V2X sidelink communication, the UE (re-) starts the dataInactivityTimer;

upon reception of a MAC SDU for sidelink for the STCH logical channel or the SCCH logical channel for NR sidelink communication, the UE (re-) starts the dataInactivityTimer;

upon reception of a MAC SDU for the DTCH logical channel, or the DCCH logical channel, or the CCCH logical channel, the UE starts/restarts the dataInactivityTimer. The DTCH, DCCH and CCCH logical channels carry the MAC SDUs for communication between the UE and the gNB. The UE receives the MAC SDU for the DTCH logical channel, or the DCCH logical channel, or the CCCH logical channel from the gNB;

upon transmission of a MAC SDU for the DTCH logical channel, or the DCCH logical channel, the UE starts/restarts the dataInactivityTimer. The UE transmits the MAC SDU for the DTCH logical channel, or the DCCH logical channel to the gNB.

In the above operation transmission/reception of the MAC SDU for NR sidelink communication or V2X sidelink communication is based on the NR sidelink communication configuration or the V2X sidelink communication configuration received from the gNB respectively. In other words it is not based on pre configuration. Note that the UE can be pre-configured with the NR/V2X sidelink communication configuration for NR/V2X sidelink communication transmission/reception, which the UE uses if it is not in coverage of any cell on a frequency used for the NR/V2X sidelink communication. The NR sidelink communication or V2X sidelink communication, is a mode of communication whereby UEs can communicate with each other directly over the PC5 interface using NR technology or EUTRA technology respectively without traversing any network node. Upon expiry of the dataInactivityTimer, the UE releases the RRC Connection.

In an embodiment, the UE operation is illustrated in FIG. 4. The UE is in RRC_CONNECTED (operation 401). The UE receives the dataInactivityTimer configuration from the gNB where the configuration can be received in the RRCReconfiguration message (operation 403). The UE receives the NR sidelink communication configuration for NR sidelink communication transmission/reception and/or the UE receives the V2X sidelink communication configuration for V2X sidelink communication transmission/reception (operation 405). The UE performs transmission/reception of the NR sidelink communication according to the NR sidelink communication configuration received from the gNB (operation 407). The UE performs transmission/reception of the V2X sidelink communication according to the V2X sidelink communication configuration received from the gNB (operation 407). Upon transmission of a MAC SDU for the STCH logical channel, or the SCCH logical channel for the V2X sidelink communication (if the V2X sidelink communication configuration is received from the gNB) or the NR sidelink communication (if the NR sidelink communication configuration is received from the gNB), the UE starts/restarts the dataInactivityTimer (operation 407a or 407b). Upon reception of the MAC SDU for the STCH logical channel, or the SCCH logical channel, for V2X sidelink communication (if V2X sidelink communication configuration is received from gNB) or NR sidelink communication (if NR sidelink communication configuration is received from gNB), the UE starts/restarts the dataInactivityTimer (operation 407c or 407d). Upon reception of the MAC SDU for the DTCH logical channel, or the DCCH logical channel, or the CCCH logical channel, the UE starts/restarts the dataInactivityTimer (operation 407e). Upon transmission of the MAC SDU for the DTCH logical channel, or the DCCH logical channel, the UE starts/restarts the dataInactivityTimer (operation 407f). Upon expiry of the dataInactivityTimer, the UE releases the RRC Connection (operation 409). In the above operation transmission/reception of the MAC SDU for NR sidelink communication or V2X sidelink communication is based on the NR sidelink communication configuration or the V2X sidelink communication configuration received from the gNB respectively. The NR sidelink communication or V2X sidelink communication, is a mode of communication whereby UEs can communicate with each other directly over the PC5 interface using NR technology or EUTRA technology respectively without traversing any network node.

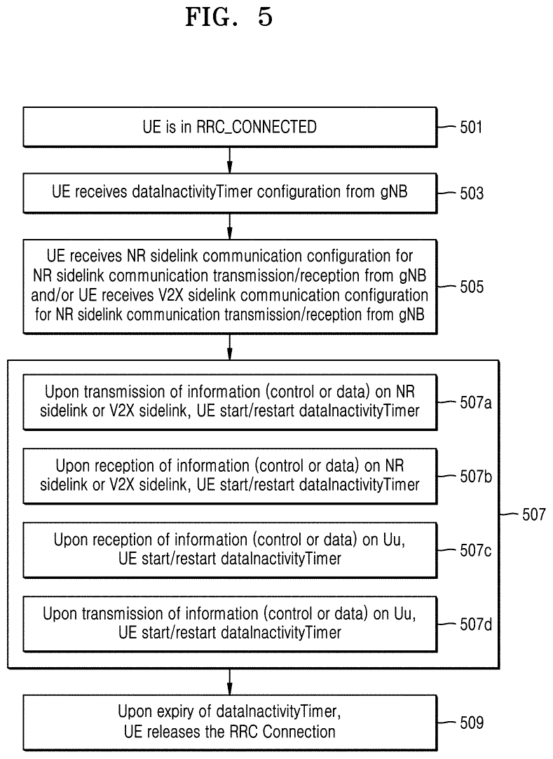

FIG. 5 illustrates a flowchart of a method, performed by a user equipment (UE), of monitoring data inactivity, according to an embodiment of the disclosure.

Referring to FIG. 5, a method, performed by a UE, of monitoring data inactivity may include operations 501 through 509. The operation 507 may include at least one of operation 507a, operation 507b, operation 507c, and operation 507d. According to various embodiments of the disclosure, operations 501 through 509 may be performed by the processor 1201 shown in FIG. 12.

In an embodiment, the UE operation is illustrated in FIG. 5. The UE is in RRC_CONNECTED (operation 501). The UE receives the dataInactivityTimer configuration from the gNB where the configuration can be received in the RRCReconfiguration message (operation 503). The UE receives the NR sidelink communication configuration for the NR sidelink communication transmission/reception and/or the UE receives the V2X sidelink communication configuration for the V2X sidelink communication transmission/reception (operation 505). The UE performs transmission/reception of the NR sidelink communication according to the NR sidelink communication configuration received from the gNB (operation 507). The UE performs transmission/reception of the V2X sidelink communication according to the V2X sidelink communication configuration received from the gNB (operation 507). Upon transmission of information (control or data) on the NR sidelink for the NR sidelink communication (if the NR sidelink communication configuration is received from the gNB), the UE starts/restarts the dataInactivityTimer (operation 507a). Upon transmission of information (control or data) on the V2X sidelink for the V2X sidelink communication (if the V2X sidelink communication configuration is received from the gNB), UE starts/restarts the dataInactivityTimer (operation 507a). Upon reception of information (control or data) on the NR sidelink for the NR sidelink communication (if the NR sidelink communication configuration is received from the gNB), the UE starts/restarts the dataInactivityTimer (operation 507b). Upon reception of information (control or data) on the V2X sidelink for the V2X sidelink communication (if the V2X sidelink communication configuration is received from the gNB), the UE starts/restarts the dataInactivityTimer (operation 507b). Upon reception of the MAC SDU for the DTCH logical channel, or the DCCH logical channel, or the CCCH logical channel, the UE starts/restarts the dataInactivityTimer (operation 507c). Upon transmission of the MAC SDU for the DTCH logical channel, or the DCCH logical channel, the UE starts/restarts the dataInactivityTimer (operation 507d). Upon expiry of the dataInactivityTimer, the UE releases the RRC Connection (operation 509). In the above operation transmission/reception of the MAC SDU for the NR sidelink communication or the V2X sidelink communication is based on the NR sidelink communication configuration or the V2X sidelink communication configuration received from the gNB respectively. The NR sidelink communication or V2X sidelink communication, is a mode of communication whereby UEs can communicate with each other directly over the PC5 interface using NR technology or EUTRA technology respectively without traversing any network node.

The UE operation for Data inactivity monitoring can be specified in the NR standard as follows:

The UE may be configured by RRC with a Data inactivity monitoring functionality, when in RRC_CONNECTED. RRC controls Data inactivity operation by configuring the timer dataInactivityTimer.

When dataInactivityTimer is configured, the UE shall:

1>if any MAC entity receives a MAC SDU for the DTCH logical channel, the DCCH logical channel, or the CCCH logical channel; or

1>if any MAC entity transmits a MAC SDU for the DTCH logical channel, or the DCCH logical channel, regardless of LBT failure indication from lower layers; or

1>if MAC entity transmits a MAC SDU for the STCH logical channel, or the SCCH logical channel using the NR sidelink communication configuration received from the gNB (or the SpCell or PCell); or

1>if MAC entity receives a MAC SDU for the STCH logical channel, or the SCCH logical channel using the NR sidelink communication configuration received from the gNB (or the SpCell or PCell); or

1>if another MAC entity (i.e. E-UTRA MAC entity) transmits a MAC SDU for the STCH logical channel, or the SCCH logical channel according to configuration received from the SpCell of this MAC entity (or using the V2X sidelink communication configuration received from the gNB (or the SpCell or PCell of this MAC entity)); or

1>if another MAC entity (i.e. E-UTRA MAC entity) receives a MAC SDU for the STCH logical channel, or the SCCH logical channel according to configuration received from the SpCell of this MAC entity (or using the V2X sidelink communication configuration received from the gNB (or the SpCell or PCell of this MAC entity)):
2>start or restart the dataInactivityTimer.

1>if the dataInactivityTimer expires:
2>indicate the expiry of the dataInactivityTimer to upper layers (i.e. RRC). The RRC releases the RRC connection and enters the RRC_IDLE upon receiving the indication.

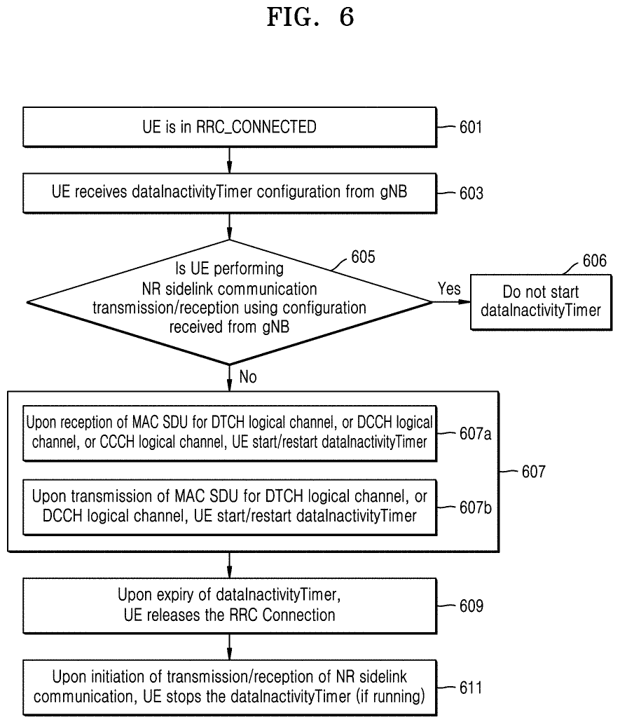

FIG. 6 illustrates a flowchart of a method, performed by a user equipment (UE), of monitoring data inactivity, according to an embodiment of the disclosure.

Referring to FIG. 6, a method, performed by a UE, of monitoring data inactivity may include operations 601 through 611. The operation 607 may include at least one of operation 607a and operation 607b. According to various embodiments of the disclosure, operations 601 through 611 may be performed by the processor 1201 shown in FIG. 12.

In one method of this disclosure it is proposed that if the dataInactivityTimer is configured by the gNB to RRC_CONNECTED UE and this UE has received the NR sidelink communication configuration from the gNB for performing the NR sidelink communication transmission/reception (or if the UE is performing transmission/reception of the NR sidelink communication using the NR sidelink communication configuration received from the gNB or if the UE is performing transmission/reception of the NR sidelink communication), the UE does not start/restart the dataInactivityTimer. If the dataInactivityTimer is configured by the gNB to RRC_CONNECTED UE and this UE has not received the NR sidelink communication configuration from the gNB for performing the NR sidelink communication transmission/reception (or the UE is not performing transmission/reception of the NR sidelink communication using the NR sidelink communication configuration received from the gNB or the UE is not performing transmission/reception of the NR sidelink communication):

upon reception of a MAC SDU for the DTCH logical channel, or the DCCH logical channel, or the CCCH logical channel, the UE starts/restarts the dataInactivityTimer. The DTCH, DCCH and CCCH logical channels carry MAC SDUs for communication between the UE and the gNB. The UE receives a MAC SDU for the DTCH logical channel, or the DCCH logical channel, or the CCCH logical channel from the gNB;

upon transmission of a MAC SDU for the DTCH logical channel, or the DCCH logical channel, the UE starts/restarts the dataInactivityTimer. The UE transmits the MAC SDU for the DTCH logical channel, or the DCCH logical channel to the gNB;

upon expiry of the dataInactivityTimer, the UE releases the RRC Connection;

upon initiation of transmission/reception of the NR sidelink communication (or upon receiving the NR sidelink communication configuration from the gNB), the UE stops the the dataInactivityTimer (if running).

In an embodiment, the UE operation is illustrated in FIG. 6.

The UE is in RRC_CONNECTED (operation 601).

The UE receives the RRCReconfiguration message from the gNB wherein the RRCReconfiguration message includes the dataInactivityTimer (operation 603).

If the UE is performing transmission/reception of the NR sidelink communication using the NR sidelink communication configuration received from the gNB (or if the UE is performing transmission/reception of the NR sidelink communication): the UE does not start/restart the dataInactivityTimer (operation 605, operation 606).

Else (i.e. the UE is not performing transmission/reception of the NR sidelink communication using the NR sidelink communication configuration received from the gNB or the UE is not performing transmission/reception of the NR sidelink communication) (operation 605, operation 607):

Upon reception of a MAC SDU for the DTCH logical channel, or the DCCH logical channel, or the CCCH logical channel, the UE starts/restarts the dataInactivityTimer (operation 607a).

Upon transmission of a MAC SDU for the DTCH logical channel, or the DCCH logical channel, the UE starts/restarts the dataInactivityTimer (operation 607b).

Upon expiry of the dataInactivityTimer, the UE releases the RRC Connection (operation 609).

Upon initiation of transmission/reception of the NR sidelink communication (or upon receiving the NR sidelink communication configuration from the gNB), the UE stops the dataInactivityTimer (if running) (operation 611). The operation 611 may be performed after the operation 609 or before the operation 609.

The UE operation for Data inactivity monitoring can be specified in the NR standard as follows:

The UE may be configured by RRC with a Data inactivity monitoring functionality, when in RRC_CONNECTED. The RRC controls the Data inactivity operation by configuring the timer dataInactivityTimer.

When the dataInactivityTimer is configured and MAC entity (or any MAC entity) is not configured to transmit/receive the NR sidelink communication (or MAC entity or any MAC entity is not configured to transmit/receive the NR sidelink communication using configuration received from the gNB(or the SpCell or PCell);), the UE shall:

1>if any MAC entity receives a MAC SDU for the DTCH logical channel, the DCCH logical channel, or the CCCH logical channel; or

1>if any MAC entity transmits a MAC SDU for the DTCH logical channel, or the DCCH logical channel, regardless of LBT failure indication from lower layers
2>start or restart the dataInactivityTimer.

1>if the dataInactivityTimer expires:
2>indicate the expiry of the dataInactivityTimer to upper layers.

1>Upon initiation of transmission/reception of the NR sidelink communication (or upon receiving the NR sidelink communication configuration from the gNB), the UE stops the dataInactivityTimer (if running)

In the above operations transmission/reception of a MAC SDU for the NR sidelink communication or the V2X sidelink communication is based on the NR sidelink communication configuration or the V2X sidelink communication configuration received from the gNB respectively. In other words it is not based on pre configuration. Note that the UE can be pre-configured with the NR sidelink communication configuration for the NR sidelink communication transmission/reception, which the UE uses if it is not in coverage of any cell on a frequency used for the NR sidelink communication. The NR sidelink communication or the V2X sidelink communication, is a mode of communication whereby UEs can communicate with each other directly over the PC5 interface using NR technology or EUTRA technology respectively without traversing any network node.

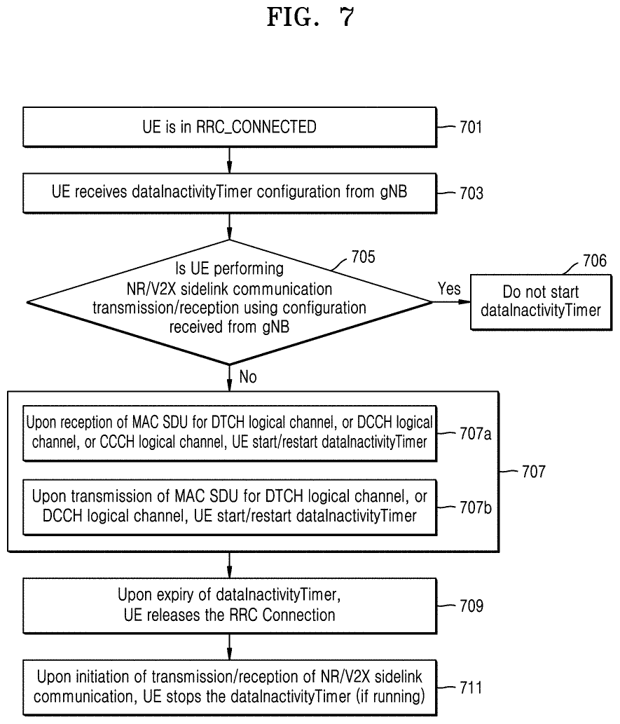

FIG. 7 illustrates a flowchart of a method, performed by a user equipment (UE), of monitoring data inactivity, according to an embodiment of the disclosure.

Referring to FIG. 7, a method, performed by a UE, of monitoring data inactivity may include operations 701 through 711. The operation 707 may include at least one of operation 707a and operation 707b. According to various embodiments of the disclosure, operations 701 through 711 may be performed by the processor 1201 shown in FIG. 12.

In one method of this disclosure it is proposed that if the dataInactivityTimer is configured by the gNB to RRC_CONNECTED UE and this UE has received the NR sidelink communication configuration or the V2X sidelink communication configuration from the gNB for performing the NR sidelink communication transmission/reception or the V2X sidelink communication transmission/reception respectively (or if the UE is performing transmission/reception of the NR/V2X sidelink communication using the NR/V2X sidelink communication configuration received from the gNB or if the UE is performing transmission/reception of the NR/V2X sidelink communication), the UE does not start/restart the dataInactivityTimer. If the dataInactivityTimer is configured by the gNB to RRC_CONNECTED UE and this UE has not received the NR/V2X sidelink communication configuration from the gNB for performing the NR/V2X sidelink communication transmission/reception (in other words the UE is not performing the NR/V2X sidelink communication using the configuration received from the gNB):

upon reception of a MAC SDU for the DTCH logical channel, or the DCCH logical channel, or the CCCH logical channel, the UE starts/restarts the dataInactivityTimer. The DTCH, DCCH and CCCH logical channels carry MAC SDUs for communication between the UE and the gNB. The UE receives the MAC SDU for the DTCH logical channel, or the DCCH logical channel, or the CCCH logical channel from the gNB;

upon transmission of a MAC SDU for the DTCH logical channel, or the DCCH logical channel, the UE starts/restarts the dataInactivityTimer. The UE transmits the MAC SDU for the DTCH logical channel, or the DCCH logical channel to the gNB;

upon expiry of the dataInactivityTimer, the UE releases the RRC Connection;

upon initiation of transmission/reception of the NR/V2X sidelink communication using configuration received from the gNB (or upon receiving the NR/V2X sidelink communication configuration from the gNB), the UE stops the dataInactivityTimer (if running).

In an embodiment, the UE operation is illustrated in FIG. 7.

The UE is in RRC_CONNECTED in NR Cell (operation 701).

The UE receives the RRCReconfiguration message from the gNB (i.e. NR Cell) wherein the RRCReconfiguration message includes the dataInactivityTimer (operation 703).

If the UE is performing transmission/reception of NR sidelink communication using the NR sidelink communication configuration received from the gNB (or if the UE is performing transmission/reception of the NR sidelink communication): the UE does not start/restart the dataInactivityTimer. Alternatively if the UE is performing transmission/reception of V2X sidelink communication using the V2X sidelink communication configuration received from the gNB (or if the UE is performing transmission/reception of the V2X sidelink communication): the UE does not start/restart the dataInactivityTimer (operation 705, operation 706).

Else (i.e. the UE is not performing transmission/reception of both NR and V2X sidelink communication using the NR/V2X sidelink communication configuration received from the gNB respectively or the UE is not performing transmission/reception of both NR and V2X sidelink communication) (operation 705, operation 707):

Upon reception of a MAC SDU for the DTCH logical channel, or the DCCH logical channel, or the CCCH logical channel, the UE starts/restarts the dataInactivityTimer (operation 707a).

Upon transmission of a MAC SDU for the DTCH logical channel, or the DCCH logical channel, the UE starts/restarts the dataInactivityTimer (operation 707b).

Upon expiry of the dataInactivityTimer, the UE releases the RRC Connection (operation 709).

Upon initiation of transmission/reception of NR/V2X sidelink communication using configuration received from the gNB i.e. NR Serving Cell or NR PCell or NR SpCell, (or upon receiving the NR/V2X sidelink communication configuration from the gNB), the UE stops the dataInactivityTimer (if running) (operation 711). The operation 711 may be performed after the operation 709 or before the operation 709.

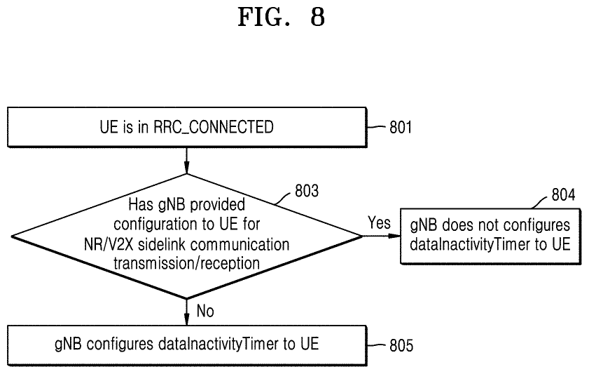

FIG. 8 illustrates a flowchart of a method, performed by a base station (BS), of monitoring data inactivity, according to an embodiment of the disclosure.

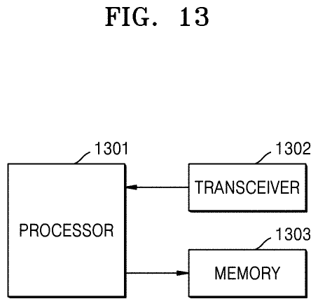

Referring to FIG. 8, a method, performed by a BS, of monitoring data inactivity may include operations 801 through 805. According to various embodiments of the disclosure, operations 801 through 805 may be performed by the processor 1301 shown in FIG. 13.

In an embodiment of this disclosure, BS(or gNB) can determine to configure data inactivity timer as shown in FIG. 8.

The UE is in RRC_CONNECTED (operation 801).

The gNB may determine whether configuration has been provided to the UE for NR/V2X sidelink communication transmission/reception. (operation 803)

If the gNB has provided configuration to the UE for NR/V2X sidelink communication transmission/reception, the gNB does not configure the dataInactivityTimer to the UE (operation 804).

Else (i.e the gNB has not provided configuration to the UE for NR/V2X sidelink communication transmission/reception) the gNB may configure the dataInactivityTimer to the UE (operation 805).

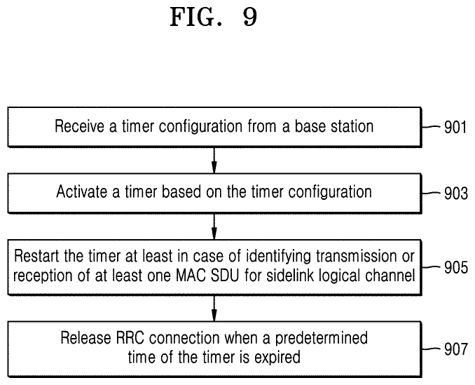

FIG. 9 illustrates a flowchart of a method, performed by a user equipment (UE), of monitoring data inactivity, according to an embodiment of the disclosure.

Referring to FIG. 9, a method, performed by a UE, of monitoring data inactivity may include operations 901 through 907. According to various embodiments of the disclosure, operations 901 through 907 may be performed by the processor 1201 shown in FIG. 12. The UE may be in a state of RRC connected.

In operation 901, the UE may receive a timer configuration from a base station (BS).

In operation 903, the UE may activate a timer based on the timer configuration.

In operation 905, the UE may restart the timer at least in case of identifying transmission or reception of at least one MAC SDU for sidelink logical channel.

In operation 907, the UE may release the RRC connection when a predetermined time of the timer is expired.

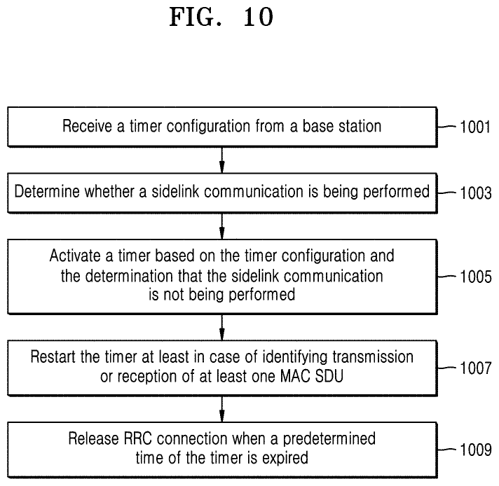

FIG. 10 illustrates a flowchart of a method, performed by a user equipment (UE), of monitoring data inactivity, according to an embodiment of the disclosure.

Referring to FIG. 10, a method, performed by a UE, of monitoring data inactivity may include operations 1001 through 1009. According to various embodiments of the disclosure, operations 1001 through 1009 may be performed by the processor 1201 shown in FIG. 12. The UE may be in a state of RRC connected.

In operation 1001, the UE may receive a timer configuration from a base station (BS).

In operation 1003, the UE may determine whether a sidelink communication is being performed.

In operation 1005, the UE may activate a timer based on the timer configuration and the determination that the sidelink communication is not being performed.

In operation 1007, the UE may restart the timer at least in case of identifying transmission or reception of at least one MAC SDU with the BS.

In operation 1009, the UE may release the RRC connection when a predetermined time of the timer is expired.

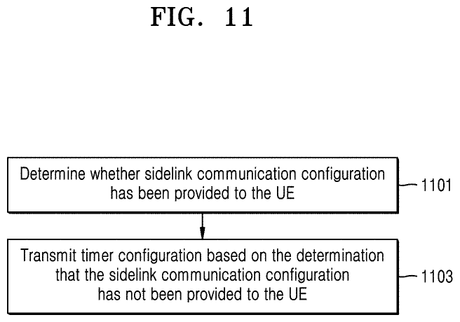

FIG. 11 illustrates a flowchart of a method, performed by a base station (BS), of monitoring data inactivity, according to an embodiment of the disclosure.

Referring to FIG. 11, a method, performed by a BS, of monitoring data inactivity may include operations 1101 and 1103. According to various embodiments of the disclosure, operations 1101 and 1103 may be performed by the processor 1301 shown in FIG. 13.

In operation 1101, the BS may determine whether sidelink communication configuration has been provided to the UE. The UE may be in state of RRC connected.

In operation 1103, the BS may transmit a timer configuration based on the determination that the sidelink communication configuration has not been provided to the UE.

FIG. 12 illustrates a block diagram of a user equipment (UE) for monitoring data inactivity, according to an embodiment of the disclosure;

Referring to FIG. 12, the UE may include a transceiver 1202, a memory 1203, and a processor 1201. The transceiver 1202, the memory 1203, and the processor 1201 of the UE may operate according to the communication method of the UE described above. However, components of the UE are not limited thereto. For example, the UE may include more or less components than those shown in FIG. 12. In addition, the transceiver 1202, the memory 1203, and the processor 1201 may be embodied in the form of a single chip.

The transceiver 1202 may transmit and receive a signal to and from a base station. Here, the signal may include control information and data. In this regard, the transceiver 1202 may include a radio frequency (RF) transmitter up-converting and amplifying a frequency of a transmitted signal and an RF receiver performing low-noise amplification on a received signal and down-converting a frequency. However, such components of the transceiver 1202 are only examples, and are not limited to the RF transmitter and the RF receiver.

Also, the transceiver 1202 may receive a signal via a wireless channel and output the signal to the processor 1201, and transmit a signal output from the processor 1201 via the wireless channel.

The memory 1203 may store a program and data required for an operation of the UE. Also, the memory 1203 may store control information or data included in a signal obtained by the UE. The memory 1203 may include a storage medium, such as read-only memory (ROM), random-access memory (RAM), a hard disk, a CD-ROM, or a DVD, or a combination thereof. Also, the memory 1203 may include a plurality of memories. According to an embodiment of the disclosure, the memory 1203 may store a program for monitoring data inactivity according to embodiments of the present disclosure.

The processor 1201 may control a series of processes such that the UE operates according to the embodiment of the disclosure. For example, the processor 1201 may control the transceiver 1202 and the memory 1203 to perform monitoring data inactivity according to embodiments of the present disclosure. Here, in relation to operations of the processor 1201, only some of the operations of the embodiments of the disclosure have been described, but the processor 1201 may control all processes such that the UE may operate according to all or some of the embodiments of the disclosure.

FIG. 13 illustrates a block diagram of a network entity for monitoring data inactivity, according to an embodiment of the disclosure;

Referring to FIG. 13, the network entity may include a transceiver 1302, a memory 1303, and a processor 1301. The transceiver 1302, the memory 1303, and the processor 1301 of the network entity may operate according to the communication method of the network entity described above. However, components of the network entity are not limited thereto. For example, the network entity may include more or less components than those shown in FIG. 13. In addition, the transceiver 1302, the memory 1303, and the processor 1301 may be embodied in the form of a single chip. According to an embodiment, the network entity may include entities included in a base station and a core network. The network entity may include the NF described above, and for example, may include an AMF, an SMF, and the like.

The transceiver 1302 may transmit and receive a signal to and from a UE, a network entity, or a base station. Here, the signal may include control information and data. In this regard, the transceiver 1302 may include an RF transmitter up-converting and amplifying a frequency of a transmitted signal and an RF receiver performing low-noise amplification on a received signal and down-converting a frequency. However, such components of the transceiver 1302 are only examples, and are not limited to the RF transmitter and the RF receiver.

Also, the transceiver 1302 may receive a signal via a wireless channel and output the signal to the processor 1301, and transmit a signal output from the processor 1301 via the wireless channel.

The memory 1303 may store a program and data required for an operation of the network entity. Also, the memory 1303 may store control information or data included in a signal obtained by the network entity. The memory 1303 may include a storage medium, such as read-only memory (ROM), random-access memory (RAM), a hard disk, a CD-ROM, or a DVD, or a combination thereof. Also, the memory 1303 may include a plurality of memories. According to an embodiment of the disclosure, the memory 1303 may store a program for supporting beam-based cooperative communication.

The processor 1301 may control a series of processes such that the network entity operates according to the embodiment of the disclosure. The processor 1301 may perform only some operations of the embodiments of the disclosure, but alternatively, may control all processes such that the network entity may operate according to all or some of the embodiments of the disclosure.

According to an embodiment of the disclosure, a method, performed by a user equipment (UE) with radio resource control (RRC) connection established, for monitoring data inactivity, may comprise receiving a timer configuration from a base station (BS), determining whether a sidelink communication is being performed, activating a timer based on the timer configuration and the determination that the sidelink communication is not being performed, restarting the timer at least in case of identifying transmission or reception of at least one media access control address (MAC) service data unit (SDU) with the BS, and releasing the RRC connection when a value of time of the timer is expired.

According to an embodiment of the disclosure, the method may further comprise receiving a sidelink communication configuration from the BS while the timer is activated and deactivating the timer in response to the receiving the sidelink communication configuration.

According to an embodiment of the disclosure, the method may further comprise identifying transmission or reception of at least one MAC SDU for sidelink logical channel with another UE and deactivating the timer in response to the identifying transmission or reception of at least one MAC SDU for sidelink logical channel.

According to an embodiment of the disclosure, the at least one MAC SDU is associated with at least one of a dedicated traffic channel (DTCH), a dedicated control channel (DCCH), and a common control channel (CCCH).

According to an embodiment of the disclosure, the transmission or the reception of at least one MAC SDU is performed with the BS using a Uu interface.

According to an embodiment of the disclosure, the sidelink communication is performed with the another UE using a PC5 interface.

According to an embodiment of the disclosure, the sidelink communication includes next generation radio (NR) sidelink communication or VX sidelink communication.

According to an embodiment of the disclosure, the timer is deactivated in case it is determined that the sidelink communication is being performed.

According to an embodiment of the disclosure, a user equipment (UE) with radio resource control (RRC) connection established, may comprise a transceiver and at least one processor. The at least one processor may configured to receive a timer configuration from a base station (BS), determine whether a sidelink communication is being performed, activate a timer based on the timer configuration and the determination that the sidelink communication is not being performed, restart the timer at least in case of identifying transmission or reception of at least one media access control address (MAC) service data unit (SDU) with the BS, and release the RRC connection when a value of time of the timer is expired.

According to an embodiment of the disclosure, the at least one processor may further be configured to receive a sidelink communication configuration from the BS while the timer is activated and deactivate the timer in response to the receiving the sidelink communication configuration.

According to an embodiment of the disclosure, the at least one processor may further be configured to identify transmission or reception of at least one MAC SDU for sidelink logical channel with another UE and deactivate the timer in response to the identifying transmission or reception of at least one MAC SDU for sidelink logical channel.

According to an embodiment of the disclosure, the at least one MAC SDU is associated with at least one of a dedicated traffic channel (DTCH), a dedicated control channel (DCCH), and a common control channel (CCCH).

According to an embodiment of the disclosure, the transmission or the reception of at least one MAC SDU is performed with the BS using a Uu interface.

According to an embodiment of the disclosure, the sidelink communication is performed with the another UE using a PC5 interface.

According to an embodiment of the disclosure, the sidelink communication includes next generation redio (NR) sidelink communication or VX sidelink communication.

According to an embodiment of the disclosure, the at least one processor further configured to deactivate the timer in case it is determined that the sidelink communication is being performed.

According to an embodiment of the disclosure, a method, performed by a base station (BS) in a wireless communication system, for monitoring data inactivity, may comprise determining whether a sidelink communication configuration has been provided to a user equipment (UE) with radio resource control (RRC) connection established and transmitting a timer configuration to the UE based on the determination that the sidelink communication configuration has not been provided to the UE.

According to an embodiment of the disclosure, the timer configuration is used for activating or deactivating a timer for monitoring data inactivity at the UE.

According to an embodiment of the disclosure, the timer is activated in case a sidelink communication is not being performed at the UE and is restarted at least in case of identification of transmission or reception of at least one media access control address (MAC) service data unit (SDU). According to an embodiment of the disclosure, the RRC connection is released when a value of time of the timer is expired.

According to an embodiment of the disclosure, a method, performed by a user equipment (UE) with radio resource control (RRC) connection established, for monitoring data inactivity, may comprise receiving a timer configuration from a base station (BS), activating a timer based on the timer configuration, restarting the timer at least in case of identifying transmission or reception of at least one media access control address (MAC) service data unit (SDU) for sidelink logical channel and releasing the RRC connection when a predetermined time of the timer is expired.

According to an embodiment of the disclosure, the sidelink logical channel may include at least one of sidelink control channel (SCCH) or sidelink traffic channel (STCH).

According to an embodiment of the disclosure, the method may further comprise restarting the timer in case of identifying transmission or reception of at least one MAC SDU associated with at least one of a dedicated traffic channel (DTCH), a dedicated control channel (DCCH), and a common control channel (CCCH).

Those skilled in the art may understand achieving all or a portion of the steps carried out by the method embodiments described above may be accomplished through commanding the associated hardware by a program, the program may be stored in a computer readable storage medium, when it is executed, one of the steps of the method embodiments or a combination thereof is included.

In addition, the functional units in the various embodiments of the present application may be integrated in a processing module, or each unit may be physically present individually, or two or more units may be integrated in one module. The integrated module may be implemented in the form of hardware, and may also be achieved in the form of software function modules. The integrated module may also be stored in a computer-readable storage medium if it is implemented in the form of a software function module and is sold or used as a standalone product.

Although the present disclosure has been particularly shown and described with reference to exemplary embodiments thereof, it will be understood by those skilled in the art that various changes in form and details may be made therein without departing from the spirit and scope of the present disclosure as defined by the following claims.

Although the present disclosure has been described with various embodiments, various changes and modifications may be suggested to one skilled in the art. It is intended that the present disclosure encompass such changes and modifications as fall within the scope of the appended claims.

What is claimed is:

1. A method, performed by a user equipment (UE) with radio resource control (RRC) connection established, for monitoring data inactivity, the method comprising:
receiving a timer configuration from a base station (BS);
determining whether a sidelink communication is being performed;
activating a timer based on the timer configuration and the determination that the sidelink communication is not being performed;
restarting the timer at least in case of identifying transmission or reception of at least one media access control address (MAC) service data unit (SDU) with the BS; and
releasing the RRC connection when a value of time of the timer is expired.

2. The method of claim 1, further comprising:
receiving a sidelink communication configuration from the BS while the timer is activated; and
deactivating the timer in response to the receiving the sidelink communication configuration.

3. The method of claim 1, further comprising:
identifying transmission or reception of at least one MAC SDU for sidelink logical channel with another UE; and
deactivating the timer in response to the identifying transmission or reception of at least one MAC SDU for sidelink logical channel.

4. The method of claim 1,
wherein the at least one MAC SDU is associated with at least one of a dedicated traffic channel (DTCH), a dedicated control channel (DCCH), and a common control channel (CCCH).

5. The method of claim 1,
wherein the transmission or the reception of at least one MAC SDU is performed with the BS using a Uu interface.

6. The method of claim 3,
wherein the sidelink communication is performed with the another UE using a PC5 interface.

7. The method of claim 1,
wherein the sidelink communication includes next generation radio (NR) sidelink communication or VX sidelink communication.

8. The method of claim 1,
wherein the timer is deactivated in case it is determined that the sidelink communication is being performed.

9. A user equipment (UE) with radio resource control (RRC) connection established, the UE comprising:
a transceiver; and
at least one processor configured to:
receive a timer configuration from a base station (BS);
determine whether a sidelink communication is being performed;
activate a timer based on the timer configuration and the determination that the sidelink communication is not being performed;
restart the timer at least in case of identifying transmission or reception of at least one media access control address (MAC) service data unit (SDU) with the BS; and
release the RRC connection when a value of time of the timer is expired.

10. The UE of claim 9, the at least one processor further configured to:
receive a sidelink communication configuration from the BS while the timer is activated; and
deactivate the timer in response to the receiving the sidelink communication configuration.

11. The UE of claim 9, the at least one processor further configured to:
identify transmission or reception of at least one MAC SDU for sidelink logical channel with another UE; and
deactivate the timer in response to the identifying transmission or reception of at least one MAC SDU for sidelink logical channel.

12. The UE of claim 9,
wherein the at least one MAC SDU is associated with at least one of a dedicated traffic channel (DTCH), a dedicated control channel (DCCH), and a common control channel (CCCH).

13. The UE of claim 9,
wherein the transmission or the reception of at least one MAC SDU is performed with the BS using a Uu interface.

14. The UE of claim 11,
wherein the sidelink communication is performed with the another UE using a PC5 interface.

15. The UE of claim 9,
wherein the sidelink communication includes next generation radio (NR) sidelink communication or VX sidelink communication.

16. The UE of claim 9, the at least one processor further configured to:
deactivate the timer in case it is determined that the sidelink communication is being performed.

17. A method, performed by a base station (BS) in a wireless communication system, for monitoring data inactivity, the method comprising:
determining whether a sidelink communication configuration has been provided to a user equipment (UE) with radio resource control (RRC) connection established; and
transmitting a timer configuration to the UE based on the determination that the sidelink communication configuration has not been provided to the UE.

18. The method of claim 17,
wherein the timer configuration is used for activating or deactivating a timer for monitoring data inactivity at the UE.

19. The method of claim 18,
wherein the timer is activated in case a sidelink communication is not being performed at the UE and is restarted at least in case of identification of transmission or reception of at least one media access control address (MAC) service data unit (SDU).

20. The method of claim 19,
wherein the RRC connection is released when a value of time of the timer is expired.
